(19) United States
(12) Patent Application Publication
(10) Pub. No.: US 2014/0145496 A1
(43) Pub. Date: May 29, 2014

(54) WHEEL SET FOR A BICYCLE

(71) Applicant: Bin Chang, Taichung City (TW)

(72) Inventor: Bin Chang, Taichung City (TW)

(21) Appl. No.: 13/735,021

(22) Filed: Jan. 6, 2013

(30) Foreign Application Priority Data
Nov. 23, 2012 (TW) 101144014

(51) Int. Cl. B60B 1/00

(52) U.S. Cl. CPC B60B 1/003
USPC 301/64.302

(57) ABSTRACT

A wheel set for a bicycle includes a wheel hub, two auxiliary disks, a plurality of spokes and a wheel rim. The two auxiliary disks sleeve onto two ends of the wheel hub respectively. Each auxiliary disk has a first ring portion and a second ring portion. The first ring portion has a plurality of ribs extended from an outer periphery thereof toward the second ring portion. One end of each spoke is assembled to ₜhe second ring portion, and another end of each spoke is assembled to an inner periphery of the wheel rim. Under this arrangement, the two auxiliary disks support the spokes bearing a torsion force and a lateral force so as to prevent the spokes from being broken and deformed.

### BACKGROUND OF THE INVENTION

1. Field of the Invention

The present invention relates to a wheel set and more particularly to a wheel set for a bicycle.

2. Description of Related Art

A conventional wheel set comprises a wheel rim, a wheel hub and a plurality of spokes. Wherein, the spokes are connected between the wheel hub and the wheel rim. However, when the spokes of the conventional wheel set suffer an excessive lateral force, the spokes are broken easily, so that the spokes need to be replaced.

In order to improve the disadvantage of the conventional wheel sets mentioned above, another conventional wheel set with spoke fixing structures has been invented. The conventional wheel set with spoke fixing structure comprises a wheel rim, a plurality of spokes and a wheel hub. The wheel hub has two fixing disk defined at two lateral sides thereof respectively. The wheel rim is connected with the wheel hub via the spokes. Each spoke comprises a vertical rod ant two inclined rods so as to form as Y-shaped. The vertical rod and the two inclined rods are flat-shaped. One end of the vertical rod is connected to the wheel rim. And one end of each inclined rod is connected to each corresponding fixing disk. Wherein, the vertical rod and the inclined rods are flat-shaped so as to reduce the wind resistance while riding the bicycle; and the three rods of each spoke are formed as a triangle structure, so that the rigidity of each spoke is increased so as to prevent the spokes from being deformed.

However, the conventional wheel set with spoke fixing structures still has one disadvantage. The conventional wheel set with spoke fixing structures cannot reduce the lateral force applied to the spokes because a length of each spoke is longer. Therefore, the spokes of the conventional wheel set are broken and deformed easily under the excessive lateral force.

The present invention has arisen to mitigate and/or obviate the disadvantages of the conventional wheel set.

### SUMMARY OF THE INVENTION

The main objective of the present invention is to provide an improved wheel set for a bicycle.

To achieve the objective, a wheel set for a bicycle comprises a wheel hub, two auxiliary disks, a plurality of spokes and a wheel rim, the two auxiliary disks sleeving onto two ends of the wheel hub respectively, each auxiliary disk having a first ring portion and a second ring portion, the first ring portion sleeving on the wheel hub, the first ring portion having a plurality of ribs extended from an outer periphery thereof toward the second ring portion and connected to an inner periphery of the second ring portion, one end of each spoke assembled to the second ring portion, the wheel rim being defined around the two auxiliary disks, a distance being defined between the wheel rim and the two auxiliary disks, another end of each spoke assembled to an inner periphery of the wheel rim. Wherein each rib is gradually enlarged from the first ring portion toward the second ring portion; each rib is arc-shaped; a diameter of each auxiliary disk is in a range from one fourth to two third of another diameter of the wheel rim; a plurality of connecting rods is defined between the two auxiliary disks; the connecting rods disperse the lateral force and the torsion force applied on the two auxiliary disks and the connecting rods sustain the two auxiliary disks securely.

Under this arrangement, the two auxiliary disks are mounted on the wheel hub and support the spokes bearing a torsion force and a lateral force so as to prevent the spokes from being broken and deformed.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wheel set for a bicycle of the present invention;

FIG. 2 is a partial exploded view of the wheel set for a bicycle;

FIG. 3 is a cross-sectional view of the wheel set for a bicycle;

FIG. 4 is a side view of the wheel set for a bicycle for showing spokes in a cross arrangement; and

FIG. 5 is a side view of the wheel set for a bicycle for showing the spokes in a radial arrangement.

### DETAILED DESCRIPTION OF THE INVENTION

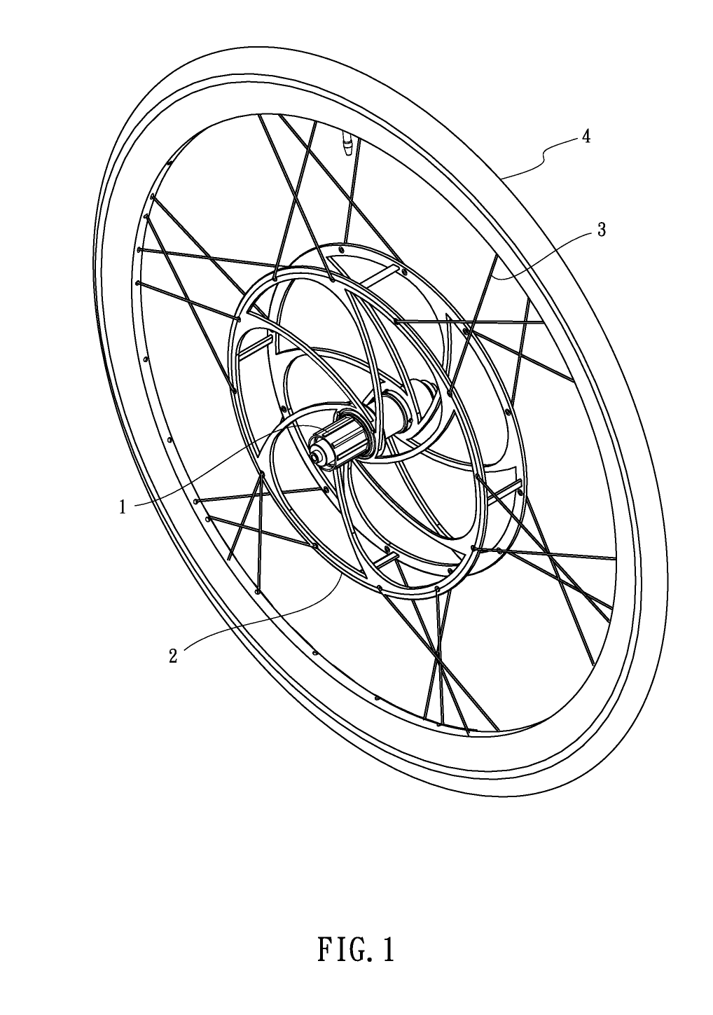

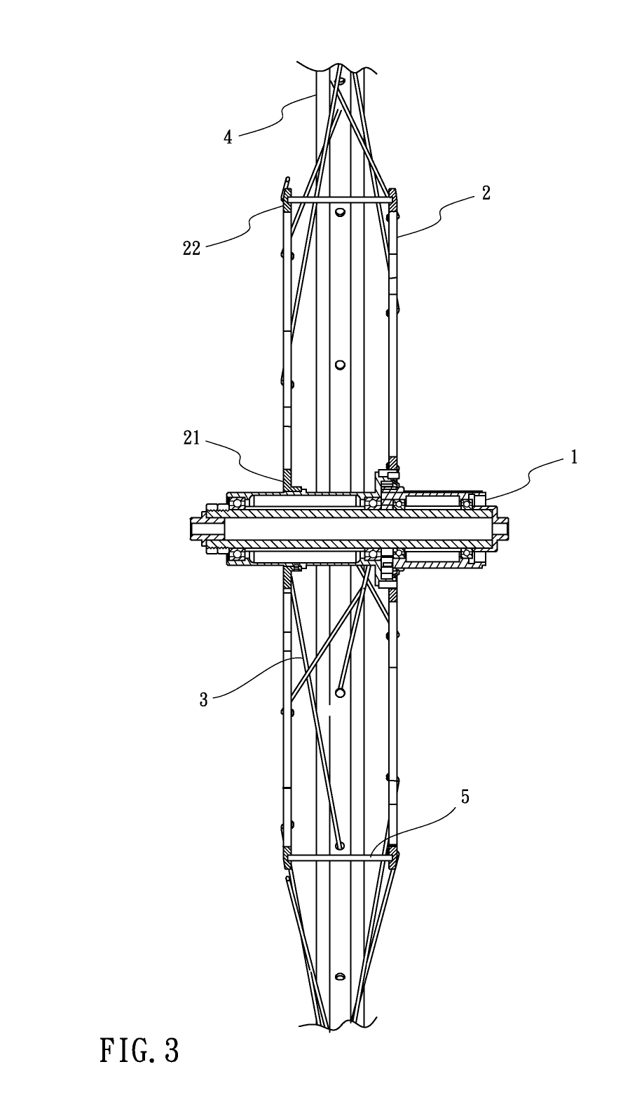

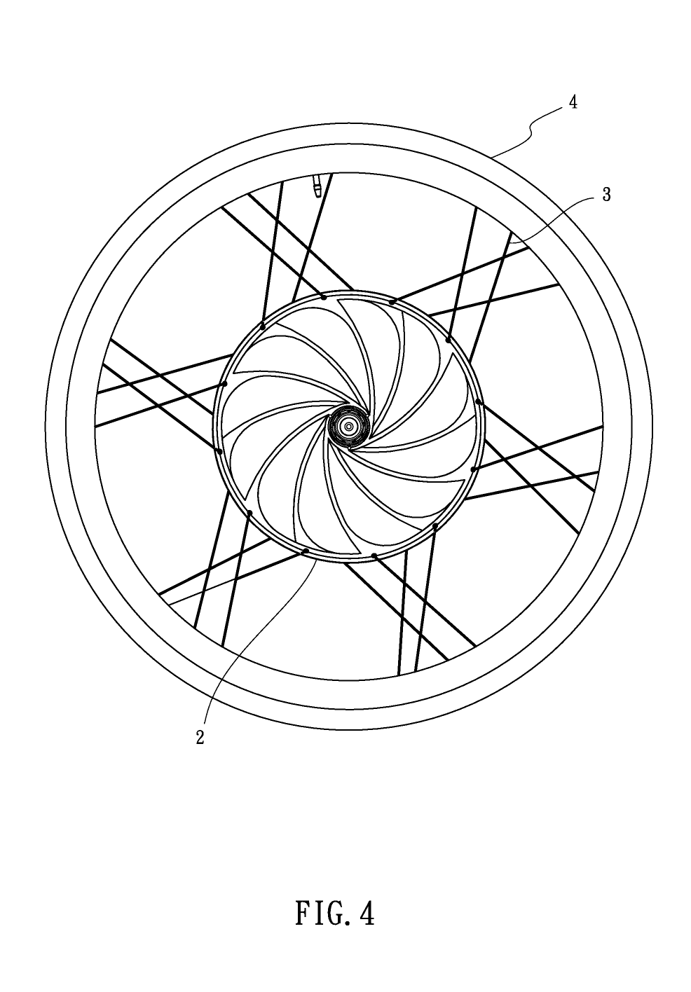

Referring to FIGS. 1-4, a wheel set for a bicycle in accordance with the present invention comprises a wheel hub 1, two auxiliary disks 2, a plurality of spokes 3 and a wheel rim 4.

The two auxiliary disks 2 sleeve onto two ends of the wheel hub 1 respectively. Each auxiliary disk 2 has a first ring portion 21 and a second ring portion 22. The first ring portion 21 sleeves on the wheel hub 1. The first ring portion 21 has a plurality of ribs 23 extended from an outer periphery thereof toward the second ring portion 22 and connected to an inner periphery of the second ring portion 22. One end of each spoke 3 is assembled to the second ring portion 22.

The wheel rim 4 is defined around the two auxiliary disks 2. A distance is defined between the wheel rim 4 and the two auxiliary disks 2. Another end of each spoke 3 is assembled to an inner periphery of the wheel rim 4.

Under this arrangement, the two auxiliary disks 2 are mounted on the wheel hub 1 and support the spokes 3 bearing a torsion force and a lateral force so as to prevent the spokes 3 from being broken and deformed.

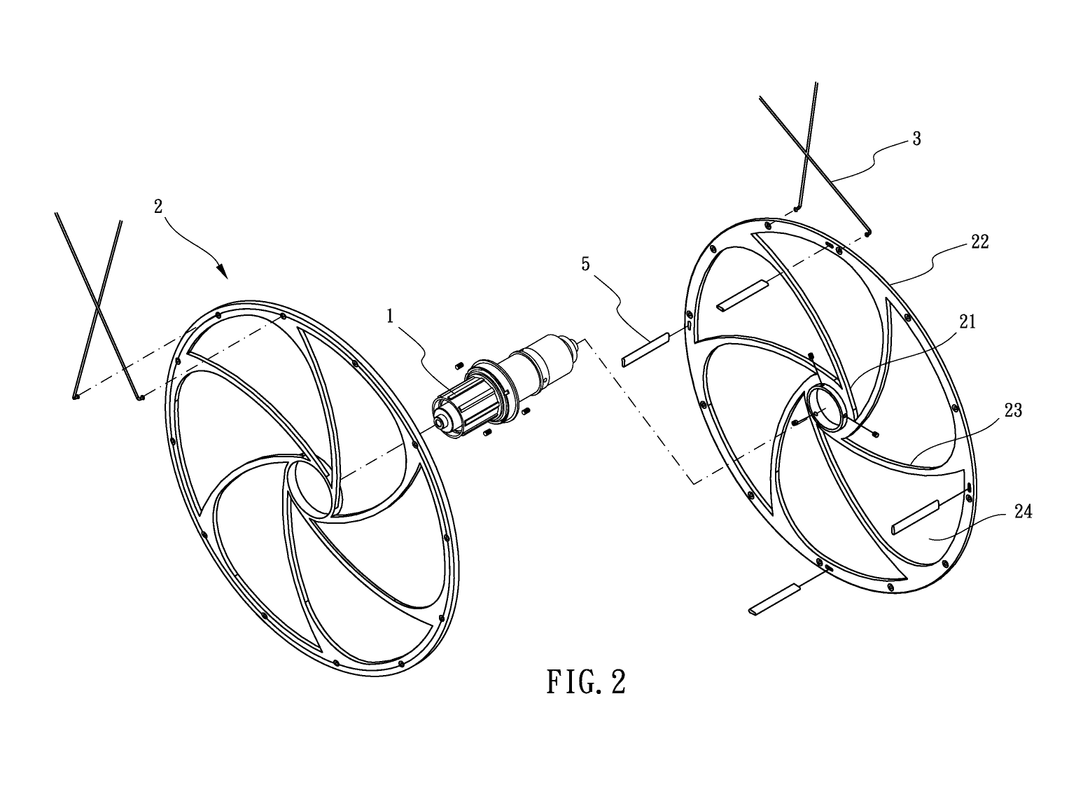

When a rider rides a bicycle on a rough road, a shock from the rough road causes the lateral force or the torsion force. Because of the lateral force and the torsion force, the spokes 3 are tensed and broken easily. Referring to FIGS. 1-2, in order to improve the above problem, a length of each spoke 3 of the present invention is shortened so as to reduce a tensile force from the lateral force and the torsion force. Therefore, the length of each spoke 3 which is connected between the two auxiliary disks 2 and the wheel rim 4 of the present invention are shorter than another length of a conventional spoke, so that the lateral force and the torsion force applied on the spokes 3 are reduced; besides, the lateral force and the torsion force are dispersed to the two auxiliary disks 2 uniformly.

In order to prevent an additional weight of the bicycle and to reduce a wind resistance while riding the bicycle, the ribs 23 of each auxiliary disk 2 which are defined between the first ring portion 21 and the second ring portion 22 are gradually enlarged from the first ring portion 21 toward the second ring portion 22; besides, each rib 23 is arc-shaped so as to reduce the wind resistance while riding the bicycle. A vent opening 24 is defined between every two adjacent ribs 23 so as to prevent the two auxiliary disks 2 from being resisted by a side wind and decelerated the bicycle. (Shapes of the ribs 23 are not limited by the present invention.)

In a preferred embodiment of each auxiliary disk 2, a diameter of each auxiliary disk 2 is in a. range from one fourth to two third of another diameter of the wheel rim 4 (as shown in FIGS. 1-2 and FIG. 4), so that the spokes 3 bear the lateral force and the torsion force and prevent the spokes 3 from being broken and deformed.

Referring to FIGS. 1-4, the present invention prevents the spokes 3 from being broken and deformed easily. In these days, the lightweight design of bicycles is dominant, so that numerous bicycle elements are made of carbon fiber or lightweight aluminum alloy. However, the lightweight materials are not rigid enough to bear an excessive force. In order to solve this problem, the present invention has a plurality of connecting rods 5 defined between the two auxiliary disks 2. The connecting rods 5 disperse the lateral force and the torsion force applied on the two auxiliary disks 2 and the connecting rods 5 sustain the two auxiliary disks 2 securely. Therefore, the connecting rods 5 prevent the two auxiliary disks 2 from being cracked or deformed. Wherein, the connecting rods 5 are connected to the two auxiliary disks 2 via means of embedding, adhering or locking. (Means of assembling the connecting rods 5 to the two auxiliary disks 2 are not limited by the present invention.)

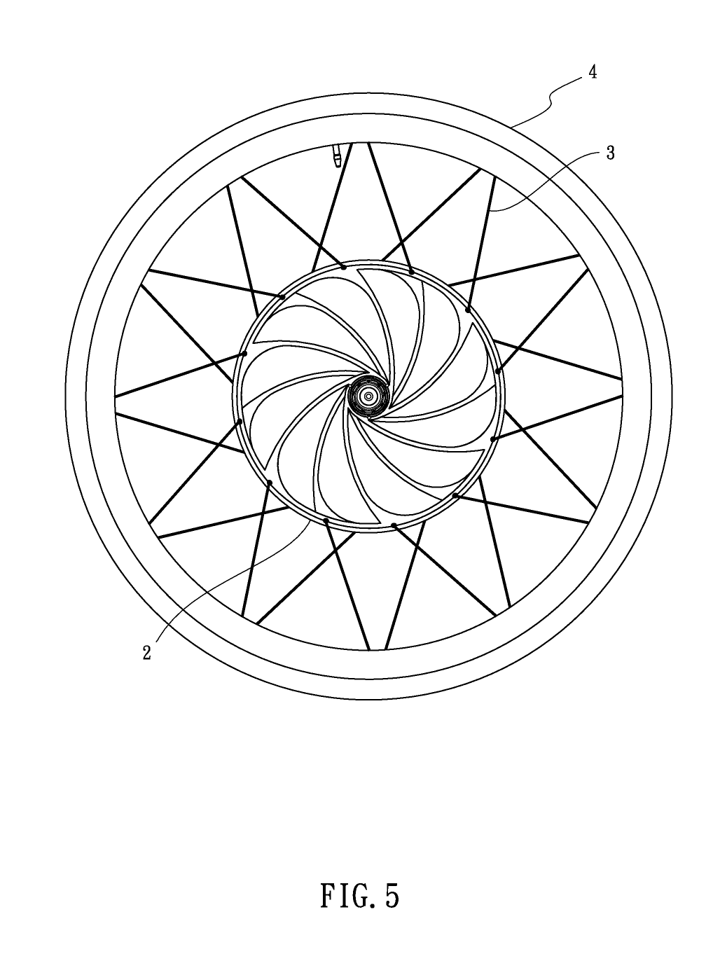

Referring to FIG. 1 and FIG. 5, the arrangement of the spokes 5 of the present invention is selectively disposed as a cross configuration or a radial configuration.

Although the invention has been explained in relation to its preferred embodiment, it is to be understood that many other possible modifications and variations can be made without departing from the spirit and scope of the invention as hereinafter claimed.

What is claimed is:

1. A wheel set for a bicycle comprising:
a wheel hub, two auxiliary disks, a plurality of spokes and a wheel rim;
the two auxiliary disks sleeving onto two ends of the wheel hub respectively, each auxiliary disk having a first ring portion and a second ring portion, the first ring portion sleeving on the wheel hub, the first ring portion having a plurality of ribs extended from an outer periphery thereof toward the second ring portion and connected to an inner periphery of the second ring portion;
one end of each spoke assembled to the second ring portion; and
the wheel rim being defined around the two auxiliary disks, a distance being defined between the wheel rim and the two auxiliary disks, another end of each spoke assembled to an inner periphery of the wheel rim;
wherein the two auxiliary disks are mounted on the wheel hub and support the spokes bearing a torsion force and a lateral force so as to prevent the spokes from being broken and deformed.

2. The wheel set for a bicycle as claimed in claim 1, wherein each rib is gradually enlarged from the first ring portion toward the second ring portion; each rib is arc-shaped.

3. The wheel set for a bicycle as claimed in claim 1, wherein a diameter of each auxiliary disk is in a range from one fourth to two third of another diameter of the wheel rim.

4. The wheel set for a bicycle as claimed in claim 1, wherein a plurality of connecting rods is defined between the two auxiliary disks; the connecting rods disperse the lateral force and the torsion force applied on the two auxiliary disks and the connecting rods sustain the two auxiliary disks securely.
